(19) United States
(12) Patent Application Publication
(10) Pub. No.: US 2006/0262761 A1
(43) Pub. Date: Nov. 23, 2006

(54) Terminal condition notification system and wireless terminal device

(75) Inventors: Taku Tsunekawa, Toda (JP); Hiroshi Sasaki, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/337,645

(22) Filed: Jan. 24, 2006

(30) Foreign Application Priority Data
Mar. 18, 2005 (JP) 2005-80360 (PAT.A
Oct. 21, 2005 (JP) 2005-307090 (PAT.

(51) Int. Cl. H04Q 7/24

(52) U.S. Cl. 370/338

(57) ABSTRACT

The present invention relates to a radiocommunication system composed of mobile phones and wireless LANs, and to a wireless terminal device. More particularly, the present invention provides a system making it possible to grasp in real time the condition of a signal received from a remote terminal device during communication, and provides a terminal device. A radiocommunication system includes a first wireless terminal device and a second wireless terminal device. During communication between the first and second wireless terminal devices, the first wireless terminal device transmits the terminal condition data of the own terminal device to the second wireless terminal device. The second wireless terminal device produces a predetermined notification on the basis of the terminal condition data received from the first wireless terminal device, and delivers the notification to the second wireless terminal device user. Thus, the first and second wireless terminal devices are notified of the conditions of the partner terminal devices in real time.

### BACKGROUND OF THE INVENTION

1. Field of the Invention

The present invention relates to a radiocommunication system including portable cellular phones and wireless LANs, and to a wireless terminal device. More particularly, the present invention is concerned with a radiocommunication system which makes it possible to grasp, in real time, the condition of a signal received from a remote terminal device during communication, and with a wireless terminal device.

2. Description of the Related Art

In radiocommunication employing portable cellular phones (hereinafter mobile phones) or wireless video phones, a wireless terminal device executes, in addition to transmission of speech or communication of images to a remote terminal device, positional registration through communication with a base station located in an area where the wireless terminal device exists or in a nearby area, or a handover required during moving. For this purpose, the wireless terminal device periodically measures the signal level received from the base station, and transmits the signal level data to the base station with the signal level data contained in an uplink control message.

In this case, the wireless terminal device displays the signal receiving condition, which the wireless terminal device has measured, on a terminal display in the form of an antenna bar or the like. Owing to the display, a terminal device user can readily learn the signal receiving condition of his/her own terminal device. On the other hand, the base station or a server included in a network and connected to the base station may hold information received from each of terminal devices, such as, signal level data or positional data. The base station or server may then check the information to determine whether each of the terminals can make a telephone call, and produce terminal condition data including the result of the determination. In this case, the terminal user issues a reading request to the base station or server so as to acquire terminal condition data of the remote terminal (refer to Patent Document 1).

(Patent Document 1) Japanese Unexamined Patent Application Publication No. 2003-124870

However, when an indicator representing a signal receiving condition measured by a terminal device itself is merely displayed on a terminal device display as conventionally, it poses a problem in that the signal receiving condition of a remote terminal device cannot be learned during a telephone call or communication. For example, when one of the terminal users who are talking with each other on their terminal devices moves outside a signal receivable range, if conversation is discontinued abruptly, the other terminal user would be at a loss because he/she cannot grasp the cause of the discontinuation. Although reconnection is impossible in this condition, the other terminal user may make a call repeatedly.

In order to acquire terminal condition data which a base station or a server included in a network has produced in response to a user's reading request, a new facility for preserving or managing terminal condition data in association with each user must be added to the base station or network. This poses a problem in that the cost of provision of the service increases. Furthermore, as terminal condition data of the other communication party is acquired in response to a user's reading request, a cause of discontinuation of a telephone call can only be checked afterward by accessing the base station or the server within the network. However, predictive information on discontinuation or the like that is likely to occur during a telephone call cannot be acquired in real time, and measures cannot be appropriately taken in advance.

### SUMMARY OF THE INVENTION

Accordingly, an object of the present invention is to provide a terminal condition notification system which makes it possible to use existing facilities included in a radiocommunication system as they are, and allowing one of terminal devices, which are engaged in a telephone call, to acquire in real time information on a signal receiving condition of the other remote terminal.

According to the present invention, there is provided a radiocommunication system including a first wireless terminal device and a second wireless terminal device. While the first and second wireless terminal devices are communicating with each other, the first wireless terminal device transmits the terminal condition data of the own terminal device to the second wireless terminal device. The second wireless terminal device produces a predetermined notification on the basis of the terminal condition data received from the first wireless terminal device, and delivers the notification to the second wireless terminal device user. Consequently, the first and second wireless terminal devices are notified of the conditions of the partner terminal devices in real time.

Moreover, according to the present invention, there is provided a radiocommunication system including a first wireless terminal device, a second wireless terminal device, and a network system. While the first and second wireless terminal devices are communicating with each other via the network system, the first wireless terminal device transmits the terminal condition data of the own terminal device to the network system. The network system transmits the received terminal condition data to the second wireless terminal device. The second wireless terminal device produces a predetermined notification on the basis of the received terminal condition data, and delivers the notification to the second wireless terminal device user. Consequently, the first and second wireless terminal devices are notified of the conditions of the partner terminal devices in real time.

Furthermore, according to the present invention, there is provided a radiocommunication system including a first wireless terminal device, a second wireless terminal device, and a network system. While the first and second wireless terminal devices are communicating with each other via the network system, the first wireless terminal device transmits the terminal condition data of the own terminal device to the network system. The network system produces a predetermined notification on the basis of the received terminal condition data, and transmits the notification to the second wireless terminal device. The second wireless terminal device delivers the received notification to the second wireless terminal device user. Consequently, the first and second wireless terminal devices are notified of the conditions of the partner terminal devices in real time.

According to the present invention, there is provided a wireless terminal device and a network system which operate in a radiocommunication system, software that realizes the wireless terminal device and network system, and a communication method to be implemented in the radiocommunication system.

According to the present invention, as the compatibility with existing wireless systems is sustained, an increase in a cost caused by providing a service according to the present invention can be avoided. Moreover, a user of a wireless terminal device can be warned in real time and in advance against occurrence of discontinuation of a telephone call attributable to the other wireless terminal device. This allows the user to take measures appropriately, for example, to make a business call earlier. Moreover, unnecessary reconnection will not be repeated after discontinuation of a telephone call or communication.

### BRIEF DESCRIPTION OF THE DRAWINGS

The present invention will be more clearly understood from the description as set forth below with reference to the accompanying drawings.

FIG. 1 illustratively shows an example of basic actions to be performed according to the present invention;

FIG. 2 describes an example of a sequence of the actions shown in FIG. 1;

FIG. 3 illustratively shows another example of the basic actions to be performed according to the present invention;

FIG. 4 describes an example of a sequence of the actions shown in FIG. 3;

FIG. 5 describes an example (1) of a phone connection sequence;

FIG. 6 describes an example (2) of the phone connection sequence;

FIG. 7 describes the first embodiment of the present invention;

FIG. 8 shows an example of a control message format;

FIG. 9 shows the second embodiment of the present invention;

FIG. 10 describes the third embodiment of the present invention;

FIG. 11 shows an example of an indicator displayed on a display as mentioned in FIG. 10; and

FIG. 12 shows an example of the configuration of a wireless terminal device in accordance with the present invention.

### DESCRIPTION OF THE PREFERRED EMBODIMENTS

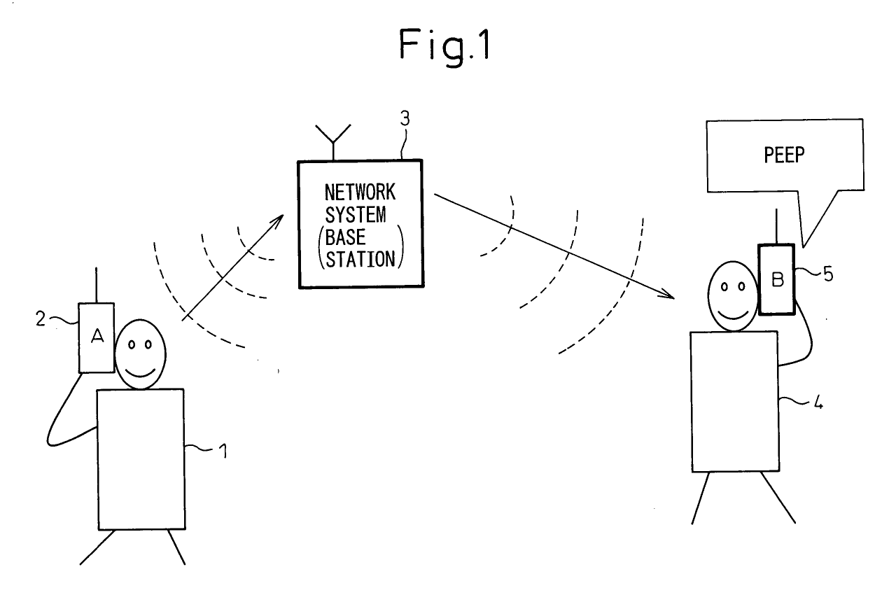

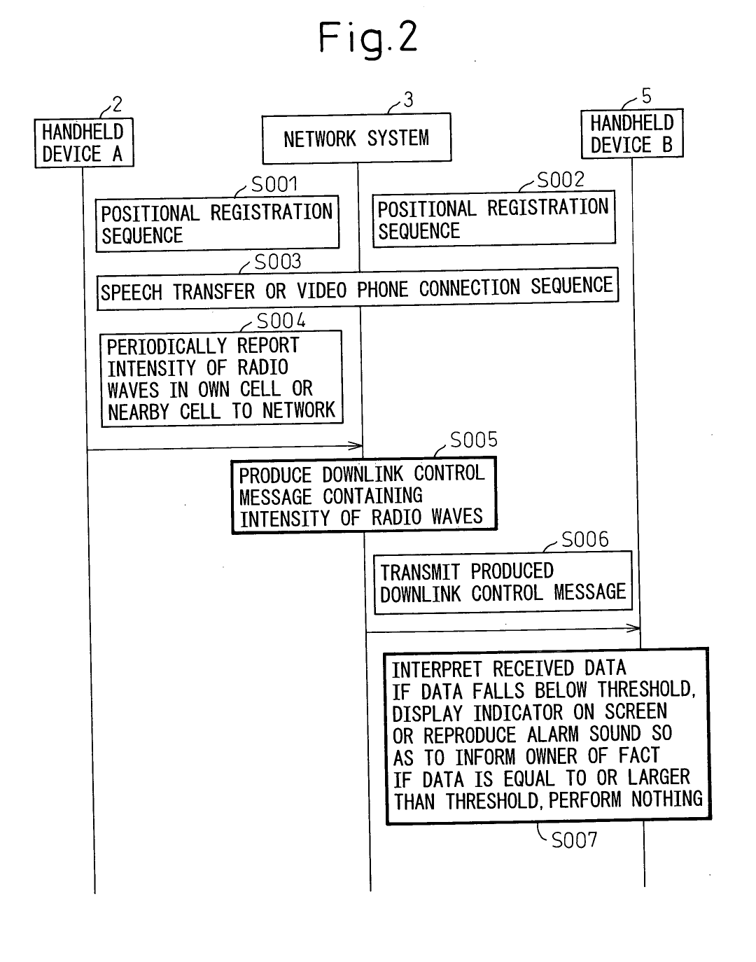

FIG. 1 illustratively shows an example of basic actions to be performed according to the present invention. FIG. 2 shows an example of a sequence of the actions shown in FIG. 1. In the drawings, squares representing components that perform pieces of processing specific to the present invention or squares describing the pieces of processing are delineated with bold lines.

In this case, a mobile station (A) 2 and a mobile station (B) 5 are terminal devices or personal digital assistants (PDAs) each having a wireless communication function. A network system 3 is a network-side communication system including base stations accommodated by a mobile communications network or a plurality of base stations and upper-level mobile telephone exchanges. As a precondition for the actions to be performed according to the present invention, first, the mobile stations 2 and 5 detect a signal sent from the network system 3 and received in areas where the respective mobile stations exist or nearby areas, and perform positional registration (S001 and S002). Thereafter, for example, the mobile station 2 originates a call to the mobile station 5, whereby the mobile stations make a telephone call (S003).

A series of actions described below are characteristic of the present invention. Herein, a description will be made of a case where the mobile station 5 is notified of the terminal condition of the mobile station 2 during a telephone call. The same applies to a case where the mobile station 2 is notified of the terminal condition of the mobile station 5 during a telephone call. Herein, the mobile station 2 periodically measures the level of a received signal such as a power received in an area where the mobile station 2 exists, and reports the measurement data to the network system 3 with the measurement data contained in an uplink control message (S004). This action is identical to the one performed by existing mobile phones.

When the network system 3 receives the uplink control message, the network system 3 samples the measurement data, which represents the signal level received by the mobile station 2, from the message. The network system 3 produces a downlink control message containing the measurement data and transmits the downlink control message to the mobile station 5 in real time (S005 and S006). The network system 3 writes the measurement data, which is sampled from the received uplink control message, in a data field defined in an existing downlink control message.

The mobile station 5 receives the downlink control message and interprets the contents of control. Herein, the mobile station 5 samples the measurement data that represents the signal level received by the mobile station 2, and compares it with a predetermined reference threshold so as to determine whether the level of a received signal is degraded. When the mobile station 5 recognizes that the signal level received by the mobile station 2 has fallen to below the predetermined reference value, the mobile station 5 gives an alarm sound “a peep” so as to warn, in advance, about the moving of the mobile station 2 out of range. If the level of a received signal is equal to or larger than the predetermined reference value, nothing is performed (S007). Consequently, a user 4 of the mobile station 5 recognizes in advance that the conversation with the user of the remote mobile station 2 with whom the user 4 is talking may soon be discontinued, and can take measures appropriately.

The foregoing terminal processing can be readily implemented by modifying the processing of “displaying an antenna bar or the like on a terminal display so as to indicate a signal receiving condition detected by a terminal device” which is performed by a conventional terminal device. Herein, the “terminal device” is changed to the “mobile station 2”, and the processing of “displaying an antenna bar or the like on the terminal display (requiring comparison)” is changed to the processing of “generating an alarm sound through comparison with the predetermined reference threshold.” Even in this case, “an indicator representing the contents of warning may be displayed on the terminal display.”

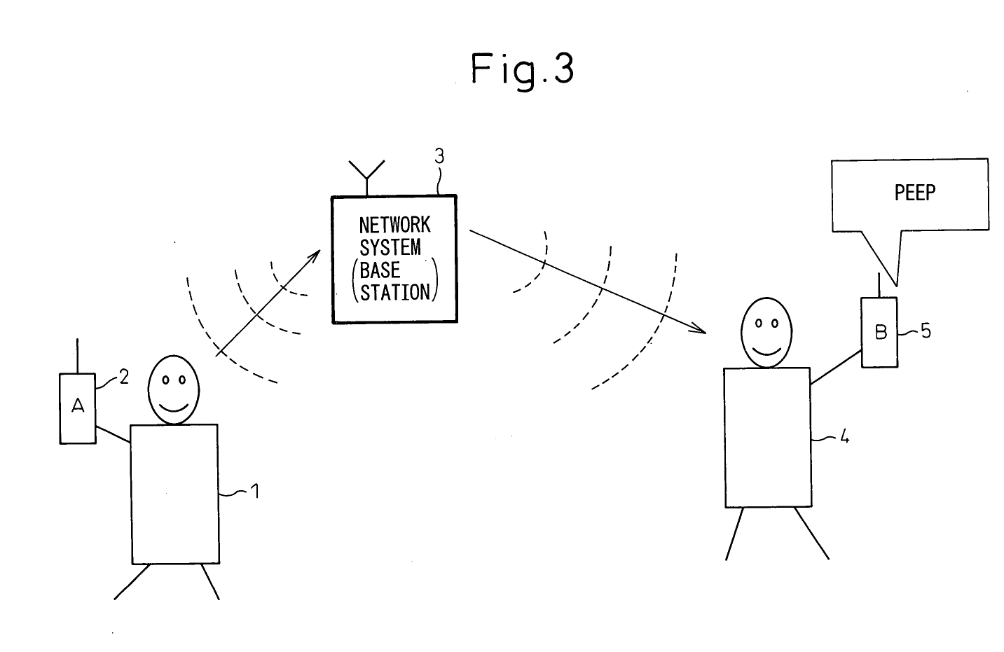

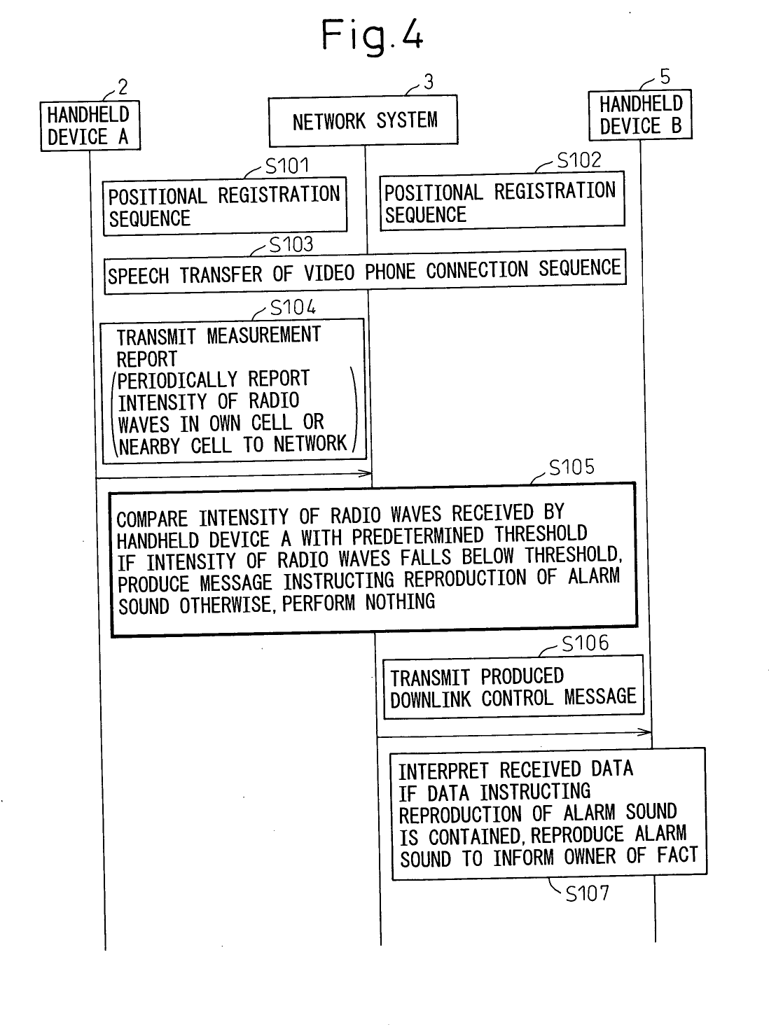

FIG. 3 illustratively shows another example of the basic actions to be performed according to the present invention. FIG. 4 describes an example of a sequence of the actions shown in FIG. 3. Squares representing components that perform pieces of processing specific to the present invention or squares describing the pieces of processing are delineated with bold lines. Incidentally, steps S101 to S103 mentioned in FIG. 4 are identical to steps S001 to S003 mentioned in FIG. 2, and the description thereof will therefore not be reiterated.

A description will be made of a case where the mobile station 5 is notified of the terminal condition of the mobile station 2 during a telephone call. The same applies to a case where the mobile station 2 is notified of the terminal condition of the mobile station 5 during a telephone call. First, the mobile station 2 periodically measures the signal level received in an area where the mobile station 2 exists, and reports the measurement data to the network system 3 with the measurement data contained in an uplink control message (S104).

In this case, when the network system 3 receives the uplink control message, the network system 3 samples the measurement data, which represents the signal level received by the mobile station 2, from the message, and compares the measurement data with a predetermined reference threshold so as to determine whether the level of a received signal is degraded. If the network system 3 recognizes that the signal level received by the mobile station 2 falls below the predetermined reference value, the network system 3 produces a downlink control message that instructs reproduction of an alarm sound or the like so as to warn in advance about the moving of the mobile station 2 out of range. If the level of a received signal is equal to or larger than the predetermined reference value, nothing is performed (S105).

When the mobile station 5 receives the downlink control message sent from the network system 3, the mobile station 5 interprets the contents of control and gives an alarm sound “a peep” in this case (S106 and S107). If the received downlink control message contains a warning indicator display instruction, “an indicator representing the contents of warning may be displayed on the terminal display.” Consequently, the user 4 of the mobile station 5 recognizes in advance that the conversation with the user of the remote mobile station 2 with whom the user 4 is talking will be soon discontinued and can take measures appropriately.

As mentioned above, the foregoing processing performed by the mobile station 5 in the case shown or described in FIG. 1 and FIG. 2 is executed by the network system 3. The mobile station 5 merely executes alarm generation or the like according to the contents of an instruction represented by a control command that instructs reproduction of a normal alarm sound or the like (S107). Consequently, existing mobile stations can be adopted as the mobile stations 2 and 5 in the present case. Moreover, the network system 3 executes the foregoing comparison or the like as long as the mobile stations 2 and 5 are engaged with a telephone call. The processing load the network system 3 incurs is therefore limited (S105).

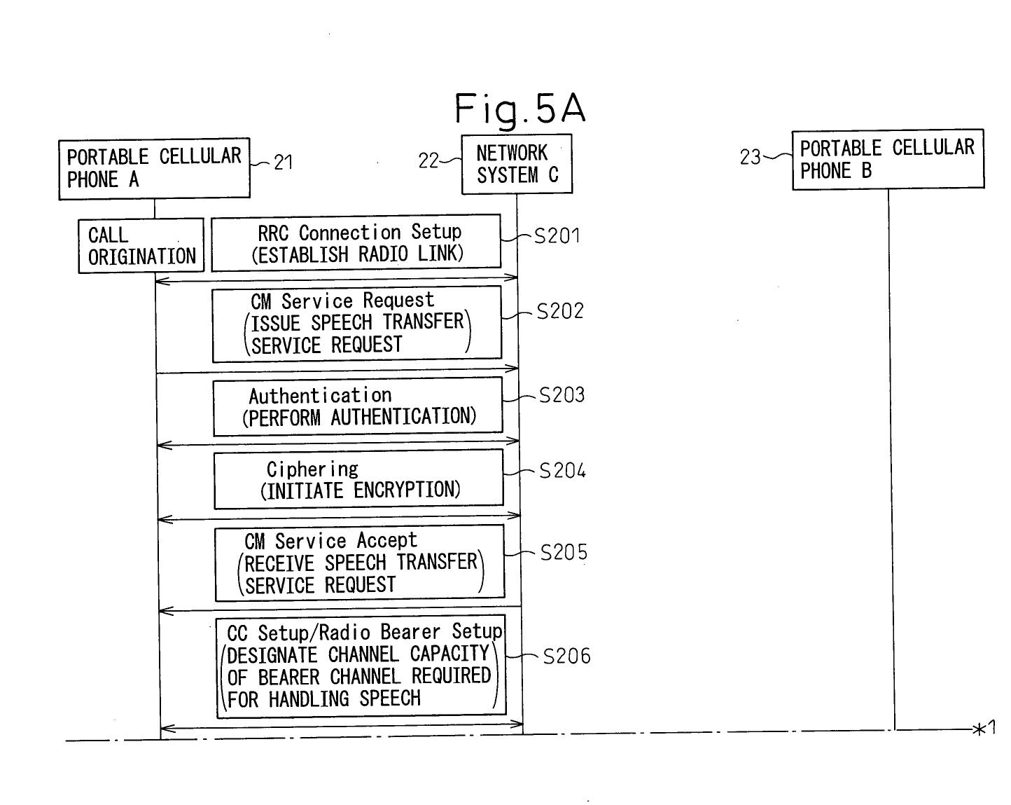

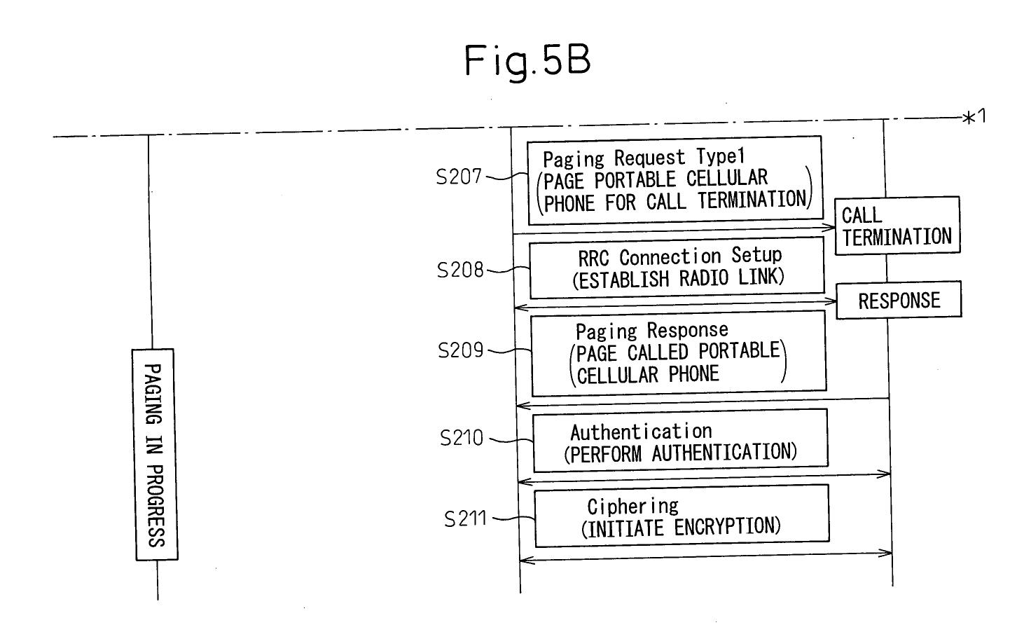

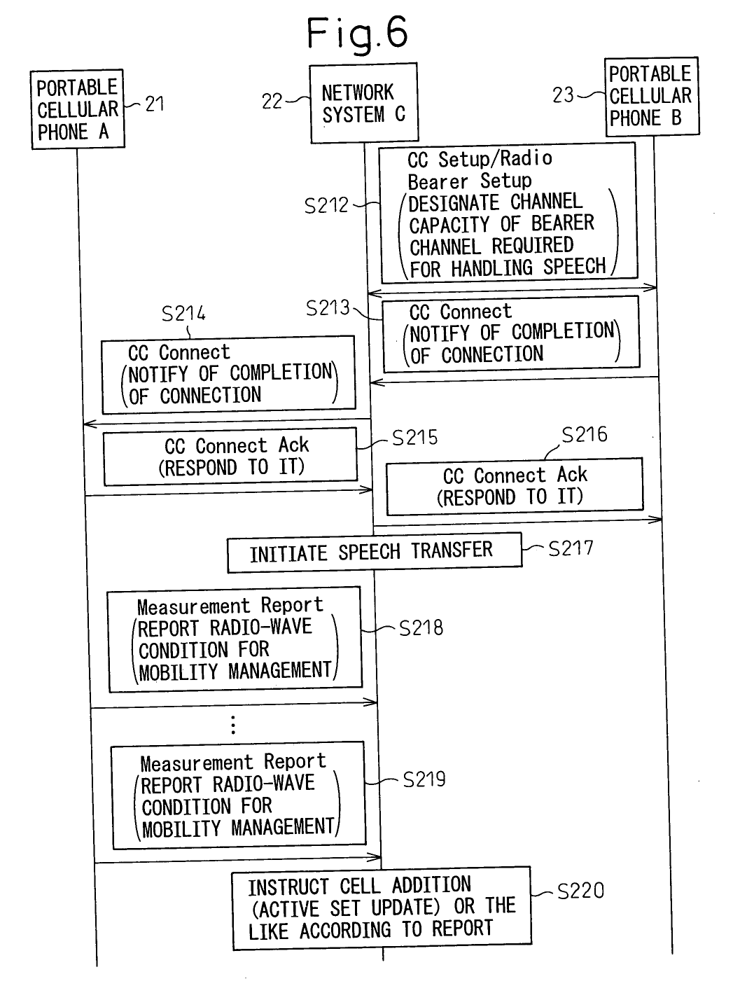

Hereinafter, an exemplary embodiment of the present invention will be described on the assumption that the present invention is adapted to W-CDMA-based IMT-2000 mobile stations A and B. First, a general phone connection sequence mentioned in FIG. 5 and FIG. 6 will be briefed below.

FIG. 5 and FIG. 6 describe a phone connection sequence to be followed in a case where a mobile station (A) 21 makes a call to a mobile station (B) 23.

For call origination from the mobile station 21 to a network system 22, the mobile station 21 establishes a radio link (communication path) with the network system (C) 22 (S201). When the radio link is established, the mobile station 21 transmits a speech transfer service request message (S202), and executes authentication and encryption relative to the network system 22 (S203 and S204). Consequently, when the network system 22 receives the speech transfer service request from the mobile station 21, the network system 22 designates the channel capacity of a bearer channel required for handling speech (S205 and S206).

Thereafter, the network system 22 initiates call termination relative to the called mobile station 23. First, the network system 22 invokes the mobile station 23 through paging, and the mobile station 23 then establishes a radio link with the network system 22 (S207 and S208). Thereafter, the called mobile station 3 executes authentication and encryption relative to the network system 22, and designates the channel capacity of the bearer channel required for handling speech (S209 to S212).

Thereafter, the called mobile station 23 notifies the network system 22 of completion of connection. Finally, a call path is set up between the called mobile station 23 and the calling mobile station 21, and the mobile stations 23 and 21 are interconnected to make a telephone call (S213 to S217). The foregoing sequence is equivalent to a concrete example of a phone connection sequence shown or described in FIG. 1 to FIG. 4 (S003 and S103). A sequence that bears a direct relation to the present invention is a sequence to be followed after speech transmission is initiated and to be described later.

In a case presented below or in an embodiment of the present invention described later, the mobile station 23 is notified of the terminal condition of the mobile station 21 during a telephone call. The same applies to a case where the mobile station 21 is notified of the terminal condition of the mobile station 23 during a telephone call.

As described in FIG. 6, after a telephone call is initiated, the mobile station 21 regularly transmits a measurement report message to the network system 22 (S218 and S219). The network system 22 manages the moving situation of the mobile station 21 according to the signal condition in an area (own cell) where the mobile station 21 exists or a nearby area (neighbor cell). Based on the message and report, the network system 22 instructs cell addition (active set update) or the like at any time for the purpose of soft-handover (S220).

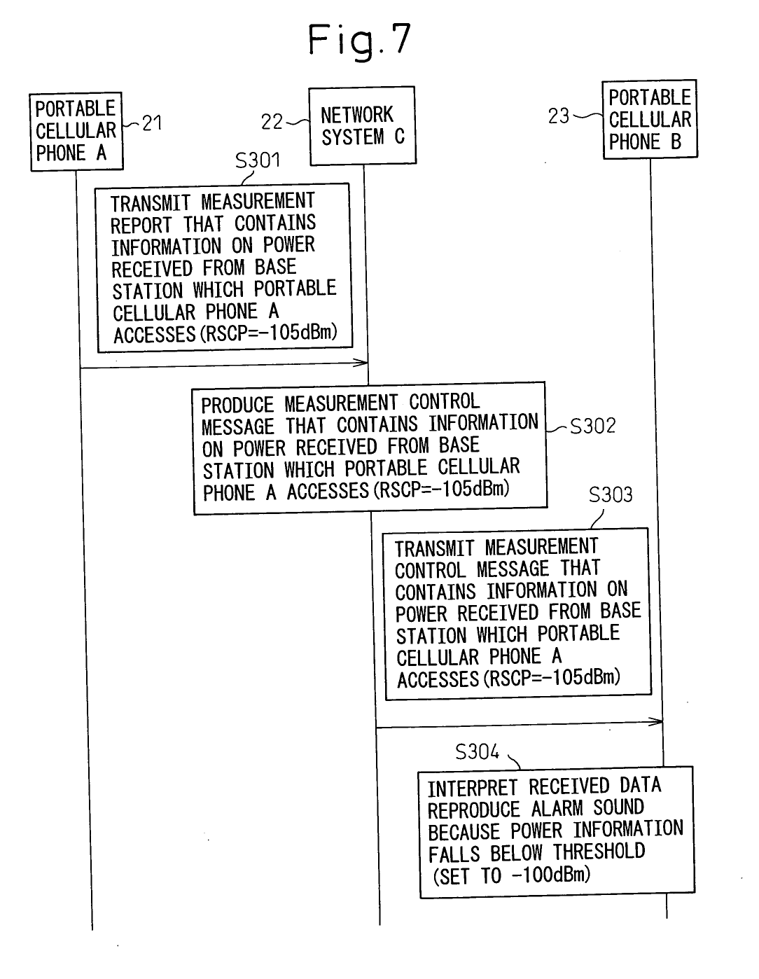

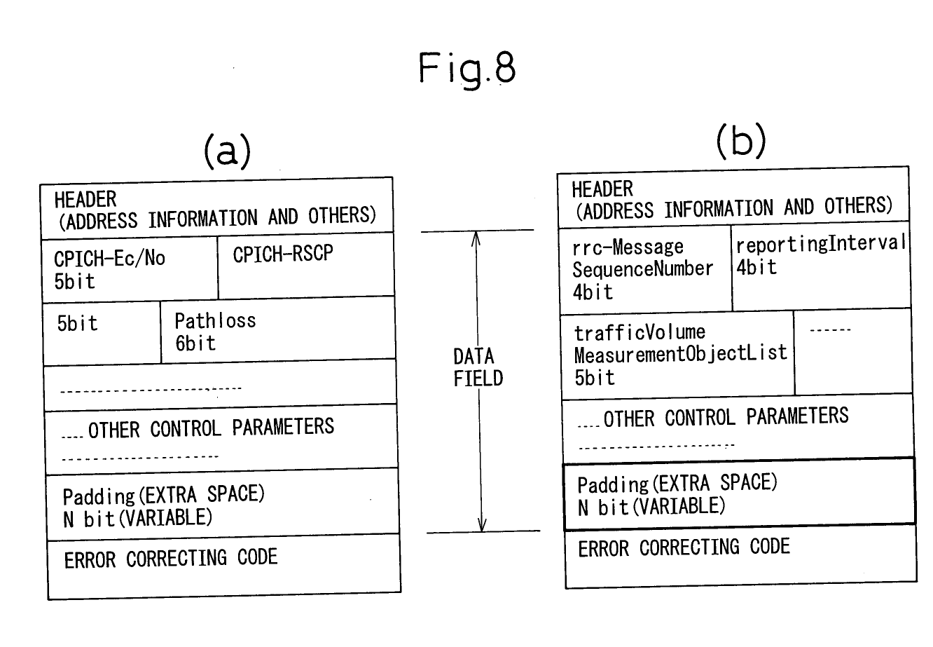

FIG. 7 shows the first embodiment of the present invention that is equivalent to a concrete example of the sequence described in FIG. 2. FIG. 8 shows an example of a format for a control message. All embodiments to be described later are concerned with processing to be performed after a telephone call is initiated between the mobile station 21 and mobile station 23 (S217 in FIG. 6).

Referring to FIG. 7, the mobile station 21 measures the signal level sent from a base station which is located in the own cell or neighbor cell and which the mobile station 21 periodically accesses, or measures received signal channel power (RSCP) (hereinafter received power) in the present embodiment. The measurement data is reported to the network system 22 by being carried by a measurement report message (S301). In the present embodiment, the power received from the base station which the mobile station 21 accesses is −105 dBm.

The network system 2 produces a measurement control message containing the received power data (RSCP=−105 dBm) carried by the received measurement report message (S302) and transmits the produced message as a downlink control message to the mobile station 23 (S303).

FIG. 8 shows an example of a control message. FIG. 8(a) shows an example of a format for the measurement report message, and FIG. 8(b) shows an example of a format for the measurement control message. In this embodiment, the received power data (RSCP=−105 dBm) recorded in a data field in the measurement report message is copied into, for example, a padding field (delineated with a bold-line square) in the measurement control message (S302).

When the mobile station 23 receives the measurement control message from the network system 22, the mobile station 23 samples the received power data (RSCP=−105 dBm) from the padding field, and compares it with a reference threshold (Ref=−100 dBm in the present embodiment), which is preserved in the mobile station 23, so as to determine whether the received power is degraded. In this case, the network system 3 determines that the received power of the mobile station 21 is below the reference value (RSCP<Ref), and reproduces an alarm sound or the like so as to warn about the moving of the mobile station 21 out of range. If the received power is equal to or larger than the reference value (RSCP>Ref), nothing is performed (S304). Incidentally, the actions performed by the mobile station 23 are, as described in conjunction with FIG. 2, readily implemented by modifying existing phone control firmware or the like.

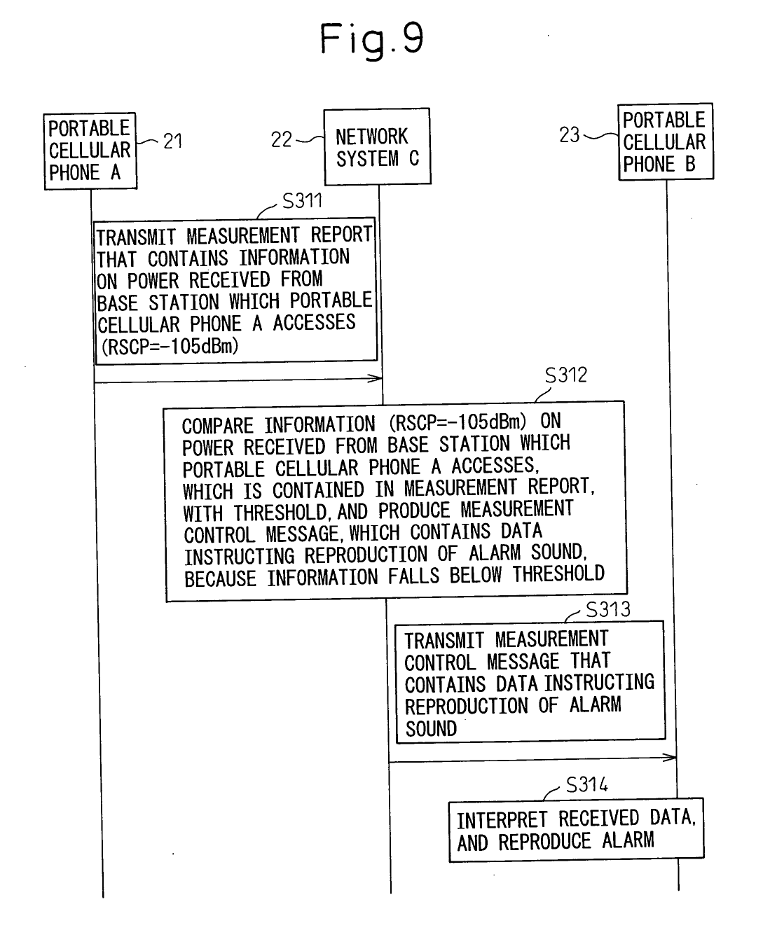

FIG. 9 describes the second embodiment of the present invention that is equivalent to a concrete example of the sequence described in FIG. 4.

Referring to FIG. 9, the network system 22 executes degradation recognition, which is equivalent to step S304 performed by the mobile station 23, for determining whether the received power of the mobile station 21 is degraded (S312). If the network system 22 recognizes the necessity of reproducing an alarm sound in the mobile station 23, the network system 22 transmits a measurement control message, which signifies the necessity of reproducing an alarm sound, to the mobile station 23 (S313). In the present embodiment, an alarm reproduction instruction is written in, for example, the padding field (FIG. 8(b)) defined in the measurement control message.

When the mobile station 23 receives the measurement control message, the mobile station 23 samples the alarm reproduction instruction from the padding field, and reproduces an alarm sound according to the instruction (S314). As described in conjunction with FIG. 4, according to the present embodiment, existing mobile stations can be, in principle, adopted as they are. Moreover, the network system 3 can be realized merely by adding simple software.

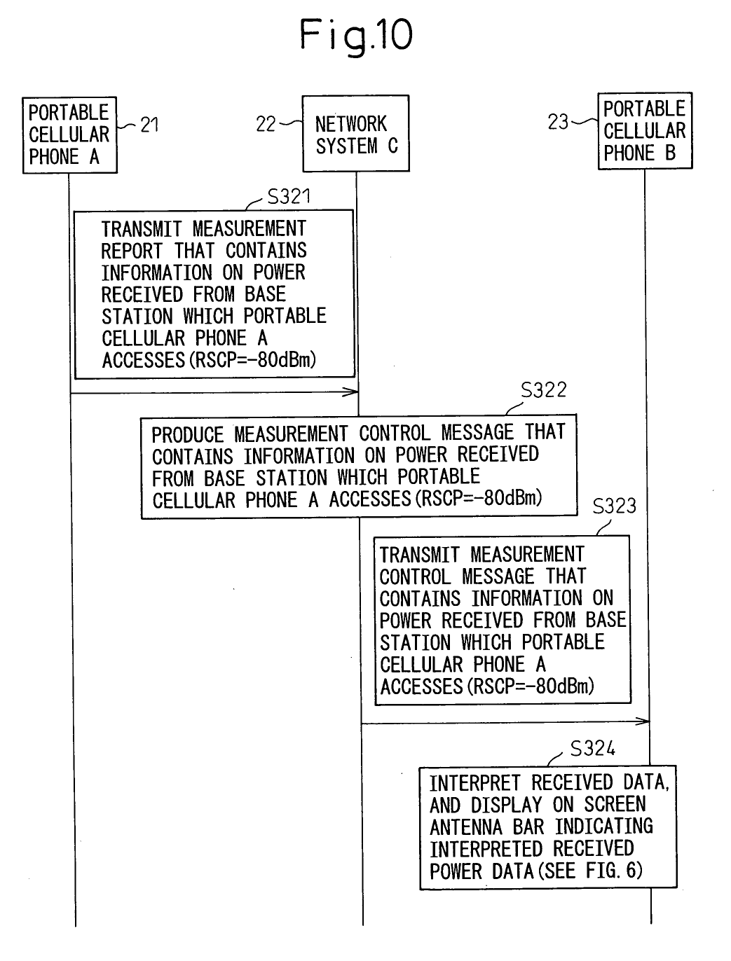

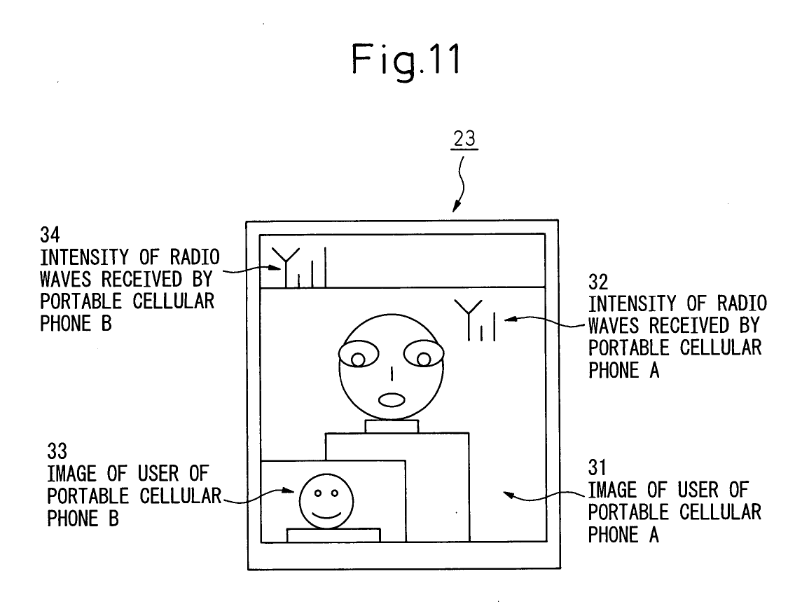

FIG. 10 describes the third embodiment of the present invention. Although FIG. 10 describes an embodiment different from the first embodiment of the present invention (FIG. 7), the contents of FIG. 10 can be adapted to the second embodiment of the present invention (FIG. 9). Moreover, FIG. 11 shows an example of an indicator displayed on a display as mentioned in FIG. 10. The present embodiment expects use of a portable video phone unit (hereinafter, simply, a mobile station) on which a user talks with a remote party while looking at an image of the face.

In the present embodiment, only the contents of processing of step S324 mentioned in FIG. 10 are different from the contents of processing of step S304 mentioned in FIG. 7. At step S324, the mobile station 23 samples received power data (RSCP=−105 dBm) from a measurement control message received from the network system 22, converts the data into an indicator that is an antenna bar, and displays the antenna bar on a terminal display.

FIG. 11 shows an example of the indicator. Herein, an image of the user of the mobile station (A) 21 that is a caller originating a call to the mobile station (B) 23 is displayed on a large screen portion (31). An antenna bar (32) into which the received power data has been converted is displayed at the right upper corner of the large screen portion. On the other hand, an image of the user of the mobile station 23 is displayed on a small screen portion (33) at the left lower corner of the terminal display. Moreover, a large antenna bar is displayed on the upper part (34) of the terminal display in order to indicate in an easily understandable manner the level of a signal sent from the mobile station 23.

Even in the present embodiment, a conventional application for displaying an antenna bar indicator can be adapted after it is modified. Moreover, the antenna bar display employed in the present embodiment may be used in combination with the alarm reproduction described in FIG. 7. Assuming that the present embodiment is adapted to the embodiment described in FIG. 9, the mobile station 23 receives indicator data, which represents an antenna bar indicator into which the level of a received signal is converted, from the network system 22. Even in this case, both antenna bar display and alarm reproduction can be performed simultaneously in combination with employment of an alarm reproduction instruction.

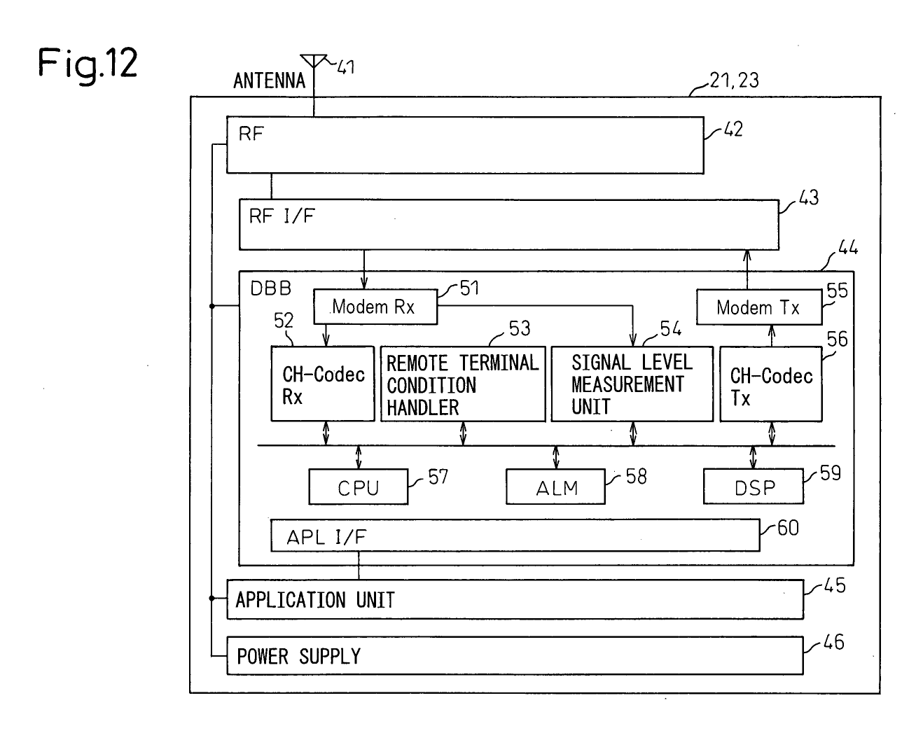

FIG. 12 is a circuit block diagram showing an example of the mobile stations 21 and 23 in accordance with the present invention.

Referring to FIG. 12, a radiofrequency unit 42 connected to an antenna 41 transmits or receives a radiofrequency signal to or from the network system 22 using any of various communication techniques including the CDMA, and interfaces with a digital baseband unit (DBB) 44 via a radiofrequency interface (RF I/F) 43.

In the digital baseband unit (DBB) 44, a modem receiver (Model Rx) 51 demodulates a received signal. A channel codec receiver (CH-Codec Rx) 52 converts the demodulated signal into a received speech signal or a received data signal that falls within the concerned channel. Moreover, a signal level measurement unit 54 uses a predetermined reception level signal, which is transmitted from the receiver 51, to periodically measure a signal level received in an area where the own terminal device is present.

A CPU 57 that controls the entire mobile station produces a measurement report message containing information on a measured received signal level. The message is transmitted to a base station via a channel codec transmitter (CH-Codec Tx) 56 and a modem transmitter (Modem Tx) 55. Needless to say, a transmitted speech signal is also transmitted to a base station via the channel codec transmitter 56 and modem transmitter 55. The mobile station has the same configuration as any existing mobile station.

The present invention further includes a remote terminal condition handler 53. Based on information on a current signal level received directly from a remote terminal device or information on the condition of the remote terminal device (measurement control message) notified by the network system 22, the remote terminal condition handler 53 causes an alarm sound generator (ALM) 58 to generate an alarm sound and/or causes a display unit (DSP) 59, which is realized with a liquid crystal display or the like, to display the contents of warning or the current signal level received from the remote terminal device. Specifically, the CPU 57 realizes the capability of the remote terminal condition handler 53.

The foregoing various pieces of processing are implemented when the CPU 57 runs programs, which are stored in an application unit 45, via an application interface (APL I/F) 60. A power supply 46 is realized with a battery and a power supply circuit from which power is supplied to the mobile station 21 or 23.

The configuration of the network system 22 included in the present invention is not especially illustrated. In the aforesaid first embodiment of the present invention, the network system 22 is fundamentally identical to any existing network system except that a message is rewritten (see FIG. 8). Even in the second embodiment of the present invention, the network system 22 is identical to an existing network system except that the remote terminal condition handler 53 shown in FIG. 12 is included in the network system 22 and designed to perform processing which used to be performed by a receiving terminal device.

According to the present invention, as compatibility with existing wireless systems is sustained, an increase in a cost caused by providing a service according to the present invention can be avoided. Moreover, a user of one of wireless terminal devices can be warned in real time in advance about occurrence of discontinuation of a telephone call attributable to the other wireless terminal device. This allows the user to take measures appropriately, for example, to make a business call earlier. Moreover, unnecessary reconnection will not be repeated after discontinuation of a telephone call or communication.

### Remarks

1. A radiocommunication system comprising a first wireless terminal device and a second wireless terminal device, wherein:

while the first and second wireless terminal devices are communicating with each other, the first wireless terminal device transmits the terminal condition data of the own terminal device to the second wireless terminal device;

the second wireless terminal device produces a predetermined notification on the basis of the terminal condition data received from the first wireless terminal device, and delivers the notification to the second wireless terminal device user; and

the first and second wireless terminal devices are thus notified of the conditions of the partner terminal devices in real time.

2. A radiocommunication system comprising a first wireless terminal device, a second wireless terminal device, and a network system, wherein:

while the first and second wireless terminal devices are communicating with each other via the network system, the first wireless terminal device transmits the terminal condition data of the own terminal device to the network system;

the network system transmits the received terminal condition data to the second wireless terminal device;

the second wireless terminal device produces a predetermined notification on the basis of the received terminal condition data, and delivers the notification to the second wireless terminal device user; and

the first and second wireless terminal devices are thus notified of the conditions of the partner terminal devices in real time.

3. A radiocommunication system comprising a first wireless terminal device, a second wireless terminal device, and a network system, wherein:

while the first and second wireless terminal devices are communicating with each other via the network system, the first wireless terminal device transmits the terminal condition data of the own terminal device to the network system;

the network system produces a predetermined notification on the basis of the received terminal condition data, and transmits the notification to the second wireless terminal device;

the second wireless terminal device delivers the received notification to the second wireless terminal device user; and

the first and second wireless terminal devices are thus notified of the conditions of the partner terminal devices in real time.

4. The radiocommunication system according to Remark 2, wherein transmission from the first wireless terminal device to the network system is performed using a predetermined report message at intervals of a certain period, and transmission from the network system to the second wireless terminal device is performed using a predetermined control message produced based on the received report message.

5. The radiocommunication system according to Remark 1, wherein the terminal condition data of the own terminal device is the signal level received in an area where the first wireless terminal device exists, and the notification to be delivered to the user of the second wireless terminal device is a warning alarm that warns against the moving of the first wireless terminal device, and/or an indicator that indicates the signal level received from the first wireless terminal device.

6. A communication method according to which a first wireless terminal device and a second wireless terminal device that are included in a radiocommunication system communicate with each other, wherein:

the first and second wireless terminal devices initiate radiocommunication;

during the communication, the first wireless terminal device transmits the terminal condition data of the own terminal device to the second wireless terminal device;

the second wireless terminal device produces a predetermined notification on the basis of the terminal condition data received from the first wireless terminal device, and delivers the notification to the second wireless terminal device user; and

the first and second wireless terminal devices are thus notified of the conditions of the partner terminal devices in real time.

7. A communication method according to which a first wireless terminal device and a second wireless terminal device that are included in a radiocommunication system communicate with each other via a network system also included in the radiocommunication system, wherein:

the first and second wireless terminal devices initiate communication via the network system;

during the communication, the first wireless terminal device transmits the terminal condition data of the own terminal device to the network system;

the network system transmits the received terminal condition data to the second wireless terminal device;

the second wireless terminal device produces a predetermined notification on the basis of the received terminal condition data, and delivers the notification to the second wireless terminal device user; and

the first and second wireless terminal devices are thus notified of the conditions of the partner terminal devices in real time.

8. A communication method according to which a first wireless terminal device and a second wireless terminal device that are included in a radiocommunication system communicate with each other via a network system also included in the radiocommunication system, wherein:

the first and second wireless terminal devices initiate communication via the network system;

during the communication, the first wireless terminal device transmits the terminal condition data of the own terminal device to the network system;

the network system produces a predetermined notification on the basis of the received terminal condition data, and transmits the notification to the second wireless terminal device;

the second wireless terminal device delivers the received notification to the second wireless terminal device user; and

the first and second wireless terminal devices are thus notified of the conditions of the partner terminal devices in real time.

9. The communication method according to Remark 7, wherein transmission from the first wireless terminal device to the network system is performed using a predetermined report message at intervals of a certain period, and transmission from the network system to the second wireless terminal device is performed using a predetermined control message produced based on the report message.

10. The communication method according to Remark 6, wherein the terminal condition data of the own terminal device is a signal level received in an area where the first wireless terminal device exists, and the notification to be delivered to the user of the second wireless terminal device is a warning alarm that warns of the moving of the first wireless terminal device, and/or an indicator that indicates the signal level received from the first wireless terminal device.

11. A wireless terminal device that communicates by radio with a remote wireless terminal device via a network system, comprising:

a terminal condition transmitter that transmits the terminal condition data of the own terminal device during communication with the remote wireless terminal device;

a terminal condition receiver that receives the terminal condition data of the remote wireless terminal device; and

a notification unit that delivers a notification, which is produced based on the received terminal condition data of the remote wireless terminal device, to the own terminal device user, wherein:

the wireless terminal device is notified of the condition of the remote wireless terminal device in real time.

12. The wireless terminal device according to Remark 11, wherein the notification is instruction of a warning alarm that warns of the moving of the remote wireless terminal device to outside a coverage area, and/or display instruction of an antenna bar that indicates a signal level received from the remote wireless terminal device.

13. A program causing a computer, which controls a wireless terminal device that communicates by radio with a remote wireless terminal device via a network system, to serve as:

a terminal condition transmission means for transmitting the terminal condition data of the own terminal device during the communication with the remote wireless terminal device;

a terminal condition data reception means for receiving the terminal condition data of the remote wireless terminal device in real time;

a notification means for delivering a notification, which is produced based on the received terminal condition data of the remote wireless terminal device, to the own terminal device user.

14. A network system that controls wireless connection and radiocommunication between a first wireless terminal device and a second wireless terminal device, comprising:

a reception unit that receives terminal condition data from the first wireless terminal device during the communication between the first and second wireless terminal devices; and

a transfer unit that transfers the terminal condition data received from the first wireless terminal device to the second wireless terminal device in real time, wherein:

the first and second wireless terminal devices are thus notified of the conditions of the partner terminal devices in real time.

15. The network system according to Remark 14 wherein, for the transfer, the transfer unit produces a notification on the basis of the terminal condition data received from the first wireless terminal device, and transfers the notification to the second wireless terminal device on behalf of the terminal condition data received from the first wireless terminal device.

16. The network system according to Remark 14, wherein the notification is instruction of a warning alarm that warns of the moving of the first wireless terminal device to outside a coverage area, and/or display instruction of an antenna bar that indicates a signal level received from the remote wireless terminal device.

17. A program causing a computer, which controls a network system that controls wireless connection and radiocommunication between a first wireless terminal device and a second wireless terminal device, to serve as:

a reception means for receiving terminal condition data from the first wireless terminal device during the radiocommunication between the first and second wireless terminal devices; and

a transfer means for transferring the terminal condition data received from the first wireless terminal device to the second wireless terminal device in real time.

18. The program according to Remark 17 wherein, for the transfer, the transfer means, as which the computer is caused to serve, is a means for producing a notification on the basis of the terminal condition data received from the first wireless terminal device, and transferring the notification to the second wireless terminal device on behalf of the terminal condition data received from the first wireless terminal device.

1. A radiocommunication system comprising a first wireless terminal device and a second wireless terminal device, wherein:
while the first and second wireless terminal devices are communicating with each other, the first wireless terminal device transmits the terminal condition data of the own terminal device to the second wireless terminal device;
the second wireless terminal device produces a predetermined notification on the basis of the terminal condition data received from the first wireless terminal device, and delivers the notification to the second wireless terminal device user; and
the first and second wireless terminal devices are thus notified of the conditions of the partner terminal devices in real time.

2. A communication method according to which a first wireless terminal device and a second wireless terminal device that are included in a radiocommunication system communicate with each other, wherein:
the first and second wireless terminal devices initiate radiocommunication;
during the communication, the first wireless terminal device transmits the terminal condition data of the own terminal device to the second wireless terminal device;
the second wireless terminal device produces a predetermined notification on the basis of the terminal condition data received from the first wireless terminal device, and delivers the notification to the second wireless terminal device user; and
the first and second wireless terminal devices are thus notified of the conditions of the partner terminal devices in real time.

3. A wireless terminal device that communicates by radio with a remote wireless terminal device via a network system, comprising:
a terminal condition transmitter that transmits the terminal condition data of the own terminal device during communication with the remote wireless terminal device;
a terminal condition receiver that receives the terminal condition data of the remote wireless terminal device; and
a notification unit that delivers a notification, which is produced based on the received terminal condition data of the remote wireless terminal device, to the own terminal device user, wherein:
the wireless terminal device is notified of the condition of the remote wireless terminal device in real time.

4. The wireless terminal device according to claim 3, wherein the notification is instruction of a warning alarm that warns of the moving of the remote wireless terminal device to outside a coverage area, and/or display instruction of an antenna bar that indicates a signal level received from the remote wireless terminal device.
